(19) United States
(12) Patent Application Publication
(10) Pub. No.: US 2009/0005957 A1
(43) Pub. Date: Jan. 1, 2009

(54) ACTUATOR CONTROL SYSTEM AND ACTUATOR

(75) Inventors: Ken IMAMURA, Okazaki-shi (JP); Tatsuya Kawamura, Nagoya-shi (JP); Atsushi Honda, Seto-shi (JP)

Correspondence Address: SUGHRUE MION, PLLC, 2100 PENNSYLVANIA AVENUE, N.W., SUITE 800, WASHINGTON, DC, 20037, US

(73) Assignee: TOYOTA JIDOSHA KABUSHIKI KAISHA, Toyota-shi (JP)

(21) Appl. No.: 12/143,973

(22) Filed: Jun. 23, 2008

(30) Foreign Application Priority Data
Jun. 29, 2007 (JP) 2007-171785

(51) Int. Cl. F02D 45/00

(52) U.S. Cl. 701/115; 91/358 R

(57) ABSTRACT

A control system includes a nonvolatile memory of an electronic controller, which stores information regarding operation characteristics of a hydraulic-pressure control valve that serves as an actuator in advance, and an electronic control unit that controls an operation of the hydraulic-pressure control valve based on the information. The electronic control unit is formed separately from the hydraulic-pressure control valve. The electronic controller is formed integrally with the hydraulic-pressure control valve. The control system and the actuator simplify a work for replacing the electronic control unit or the actuator.

### INCORPORATION BY REFERENCE

The disclosure of Japanese Patent Application No. 2007-171785 filed on Jun. 29, 2007, including the specification, drawings and abstract is incorporated herein by reference in its entirety.

### BACKGROUND OF THE INVENTION

1. Field of the Invention

The invention relates to an actuator control system that controls the operation of an actuator based on pre-stored information regarding operation characteristics of the actuator, and an actuator that is provided in the actuator control system.

2. Description of the Related Art

Recently, a control system that includes an actuator and an electronic control unit has come into widespread use as a system that adjusts control parameters. In the control system, a drive signal that is prepared based on a result of calculation made by the electronic control unit is output, and the operation of the actuator is controlled based on the drive signal.

Because there is an individual difference among actuators, the operation characteristics differ from one actuator to another due to the individual difference. Such difference in the operation characteristics of the actuators is one of the factors that reduce the accuracy of adjustment of the control parameters.

To address such a problem, for example, Japanese Patent Application Publication No, 05-215206 (JP-A-05-215206) describes actuator control technology, and the described technology is in practical application. According to JP-A-05-215206, the information regarding the operation characteristics of the actuator (characteristic information) is obtained in advance and stored in an electronic control unit, and the electronic control unit controls the operation of the actuator based on the characteristic information. Through the operation control, an actual value of the control parameter is brought to a target value. As a result, the electronic control unit accurately controls the operation of the actuator independently of the difference in the operation characteristic of the actuator.

In the control system, a value indicating the characteristic information stored in the electronic control unit needs to be commensurate with the operation characteristics of the actuator in order to adjust the control parameters with high accuracy.

Therefore, when the actuator is replaced due to, for example, a malfunction, it is necessary to obtain characteristic information regarding a newly-fitted actuator and store the characteristic information in the electronic control unit. Also, when the electronic control unit is replaced, it is necessary to store the characteristic information regarding the actuator in a newly-fitted electronic control unit.

When a component, for example, the actuator or the electronic control unit of the above-described control system is replaced, it is necessary to store the characteristic information of the actuator in the electronic control unit. This makes a work for replacement of the component more cumbersome and complicated. This is one of the factors that hamper enhancement of the efficiency of replacement.

### SUMMARY OF THE INVENTION

The invention is made in light of the above-described circumstances, and therefore provides an actuator control system that simplifies a replacement work and an actuator that is suitable for the actuator control system.

A first aspect of the invention relates to a control system for an actuator, which includes: a storage unit that stores information regarding operation characteristics of the actuator in advance; and a control unit that controls an operation of the actuator based on the information, and that is formed separately from the actuator. The actuator and the storage unit are formed integrally with each other.

In the actuator control system according to the first aspect of the invention, the characteristic information of the actuator is stored in the storage unit that is formed integrally with the actuator. Therefore, even if the actuator or the control unit is replaced, the operation of the actuator is controlled in accordance with the actual operation characteristics, based on the characteristic information stored in the storage unit. Accordingly, when the actuator or the control unit is replaced, it is not necessary to do an extra work to store the characteristic information in the storage unit. As a result, the work for replacing the actuator or the control unit in the control system according to the first aspect of the invention is simpler than that in a control system in which the work for storing the characteristic information in a storage unit is required.

In the first aspect of the invention, the control system may include a plurality of the actuators which are formed integrally with the respective storage units, and each storage unit may store the information regarding the actuator that is formed integrally with the storage unit.

With the above-described actuator control system, it is possible to replace each actuator through a simple work in a control system that includes a plurality of actuators.

In the first aspect of the invention, the control system may be applied to an automatic transmission that has a plurality of gears, the automatic transmission may include a hydraulically-actuated change-over mechanism that selectively connects two components with each other or disconnects the two components from each other to change the gears, and the actuator may be a hydraulic-pressure control valve that adjusts a supply hydraulic pressure which is supplied to the change-over mechanism. In addition, the information may be a value that is used to compensate for deviation of an actual value of the supply hydraulic pressure from a target value, which is caused due to deviation of actual operation characteristics of the actuator immediately after fitting of the control system is completed from reference characteristics.

Recently, there has been proposed a control system that changes gears of an automatic transmission, which is provided with a hydraulic-pressure control valve, quickly while suppressing occurrence of shift shock. The control system changes gears quickly while suppressing occurrence of shift shock by adjusting a hydraulic pressure that is supplied to a change-over mechanism which is used to change gears through control of an operation of the hydraulic-pressure control valve based on a value stored in advance.

With the actuator control system described above, it is possible to simplify the work for replacing the hydraulic-pressure control valve or the control unit in the control system described above.

The control system may be applied to a throttle valve that adjusts a flow passage area of an intake passage of an internal combustion engine, and the actuator may be the throttle valve. Alternatively, the control system may be applied to a fuel injection valve that supplies fuel into a combustion chamber of an internal combustion engine, and the actuator may be the fuel injection valve.

With the actuator control system described above, it is possible to simplify the work for replacing the throttle valve, the fuel injection valve or the control unit in the control system described above.

A second aspect of the invention relates to an actuator which includes: a storage unit that stores information regarding operation characteristics of the actuator in advance; and a control unit that controls an operation of the actuator based on the information. The actuator is applied to a control system in which the control unit is formed separately from the actuator, and the actuator is formed integrally with the storage unit.

In the actuator according to the second aspect of the invention, the characteristic information of the actuator is stored in the storage unit that is formed integrally with the actuator. Therefore, even if the actuator is replaced, the operation of the actuator is controlled in accordance with the actual operation characteristics, based on the characteristic information stored in the storage unit. Accordingly, when the actuator is replaced, it is not necessary to do an extra work to store the characteristic information in the storage unit. As a result, the work for replacing the actuator according to the second aspect of the invention is simpler than the work for replacing an actuator, in which the work for storing the characteristic information in a storage unit is required.

In the second aspect of the invention, the actuator may be a hydraulic-pressure control valve that is provided in an automatic transmission which includes a hydraulically-actuated change-over mechanism that selectively connects two components with each other or disconnects the two components from each other to change gears, and that adjusts a supply hydraulic pressure which is supplied to the change-over mechanism. In addition, the information may be a value that is used to compensate for deviation of an actual value of the supply hydraulic pressure from a target value, which is caused due to deviation of actual operation characteristics of the actuator immediately after fitting of the control system is completed from reference characteristics.

Recently, there has been proposed a control system that changes gears of an automatic transmission, which is provided with a hydraulic-pressure control valve, quickly while suppressing occurrence of shift shock. The control system changes gears quickly while suppressing occurrence of shift shock by adjusting a hydraulic pressure that is supplied to a change-over mechanism which is used to change gears through control of an operation of the hydraulic-pressure control valve based on a value stored in advance.

With the actuator described above, it is possible to simplify the work for replacing the hydraulic-pressure control valve in the control system described above.

The actuator may be a throttle valve that adjusts a flow passage area of an intake passage of an internal combustion engine. Alternatively, the actuator may be a fuel injection valve that supplies fuel into a combustion chamber of an internal combustion engine.

With the actuator described above, it is possible to simplify the work for replacing the throttle valve, the fuel injection valve or the control unit in the control system described above.

### BRIEF DESCRIPTION OF THE DRAWINGS

The features, advantages thereof, and technical and industrial significance of this invention will be better understood by reading the following detailed description of an example embodiment of the invention, when considered in connection with the accompanying drawings, in which:

FIG. 1 is a diagram schematically showing the structure of a vehicle to which an embodiment of the invention is applied;

FIG. 2 is a table showing the relationship between the engaged/disengaged state of clutches and brakes of an automatic transmission and the shift position selected by a shift lever device;

FIG. 3 is a conceptual diagram showing the map structure of a shift map that is used to select a gear of the automatic transmission;

FIG. 4 is a timing chart showing an example of a manner in which clutch-to-clutch gear shift control is executed;

FIG. 5 is a graph showing an example of the relationship between a hydraulic pressure that is supplied to a change-over mechanism and an electric current that is supplied to a hydraulic-pressure control valve;

FIG. 6 is a table showing the relationship between a disengagement target hydraulic pressure and an electric current that is supplied to the hydraulic-pressure control valve; and

FIG. 7 is a table showing the relationship between engagement target hydraulic pressure and an electric current that is supplied to the hydraulic-pressure control valve.

### DETAILED DESCRIPTION OF TIRE EMBODIMENT

In the following description and the accompanying drawings, the invention will be described in more detail with reference to an example embodiment.

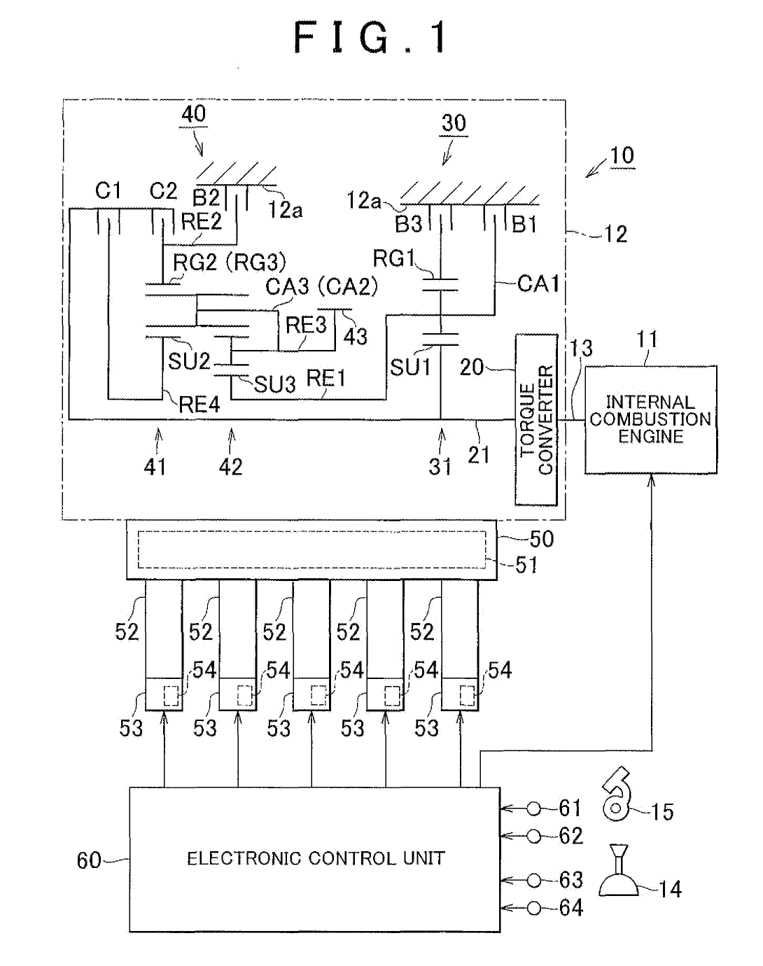

Hereafter, an embodiment of the invention will be described. First, the schematic structure of a vehicle that includes a control system according to the embodiment of the invention will be described with reference to FIG. 1.

As shown FIG. 1, a vehicle 10 includes an internal combustion engine 11, and the internal combustion engine 11 is connected to an automatic transmission 12. The automatic transmission 12 transmits the rotation of an output shaft 13 of the internal combustion engine 11 to drive wheels (not shown) while changing the rotational speed of the output shaft 13 based on the selected gear of the automatic transmission 12. The automatic transmission 12 has a case 12a. In the case 12a, a torque converter 20, a first shift mechanism 30 and a second shift mechanism 40 are provided.

The torque converter 20 is connected to the output shaft 13 of the internal combustion engine 11. The first shift mechanism 30 has a single-pinion first planetary gear set 31. The first planetary gear set 31 includes three rotational elements, that is, a sun gear SU1, a planetary carrier CA1, and a ring gear RG1. The sun gear SU1 is connected to an output shaft 21 of the torque converter 20. In the first shift mechanism 30, a third brake B3 that is used to lock the ring gear RG1 to the case 12a is provided.

When the sun gear SU1 is rotated by the output shaft 21 of the torque converter 20 and the ring gear RG1 is locked to the case 12a by the third brake B3, the rotation having a speed lower than the rotational speed of the output shaft 21 is output from the planetary carrier CA1.

The second shift mechanism 40 has a single-pinion second planetary gear set 41 and a double-pinion third planetary gear set 42. The second planetary gear set 41 and the third planetary gear set 42 include four rotational elements RE1, RE2, RE3 and RE4. More specifically, a sun gear SU3 of the third planetary gear set 42 functions as the first rotational element RE1. A ring gear RG2 of the second planetary gear set 41 and a ring gear RG3 of the third planetary gear set 42 are connected to each other so as to rotate together with each other. The ring gear RG2 and the ring gear RG3 function as the second rotational element RE2. A planetary carrier CA2 of the second planetary gear set 41 and a planetary carrier CA3 of the third planetary gear set 42 are connected to each other so as to rotate together with each other. The planetary carrier CA2 and the planetary carrier CA3 function as the third rotational element RE3. A sun gear SU2 of the second planetary gear set 41 functions as the fourth rotational element RE4.

Planet pinions of the second planetary gear set 41 and second planet pinions of the third planetary gear set 42 are meshed with each other so as to rotate together with each other. The second planet pinions of the third planetary gear set 42 are located on the outer side of first planet pinions of the third planetary gear set 42 in the direction perpendicular to the gear shaft. The first rotational element RE1 (sun gear SU3) and the planetary carrier CA1 of the first planetary gear set 31 are connected integrally with each other The third rotational element RE3 of the second shift mechanism 40, which is formed of the planetary carriers CA2 and CA3, is integrally connected with an output gear 43. The output gear 43 serves as an output portion of the automatic transmission 12. Accordingly, the rotation which is output from the output gear 43 is used to rotate the drive wheels.

In addition, the automatic transmission 12 includes a first brake B1, a second brake B2, a first clutch C1, and a second clutch C2. The first brake B1 is provided between the case 12a and the first rotational element RE1 (sun gear SU3), and used to lock the first rotational element RE1 to the case 12a. The second brake B2 is provided between the case 12a and the second rotational element RE2 (ring gears RG2 and RG3), and used to lock the first rotational element RE2 to the case 12a. The first clutch C1 is provided between the fourth rotational element RE4 (sun gear SU2) and the output shaft 21 of the torque converter 20, and used to connect the fourth rotational element RE4 to the output shaft 21. The second clutch C2 is provided between the second rotational element RE2 (ring gears RG2 and RG3) and the output shaft 21 of the torque converter 20, and used to connect the second rotational element RE2 to the output shaft 21.

The first brake B1, the second brake B2, the third brake B3, the first clutch C1, and the second clutch C2 are all hydraulically-actuated change-over mechanisms. Each of the change-over mechanisms connects two components to each other or disconnects the two components from each other to select a desired gear from among multiple gears of the automatic transmission 12. Hereinafter, the first brake B1, the second brake B2 and the third brake B3 will be collectively referred to as “brakes B”, and the first clutch C1 and the second clutch C2 will be collectively referred to as “clutches C”, unless these brakes and clutches need to be distinguished from each other.

The automatic transmission 12 is provided with a control valve 50, and a hydraulic circuit 51 is formed within the control valve 50. In the control valve 50, multiple hydraulic-pressure control valves 52, which function as actuators, are provided. In the embodiment of the invention, there are five hydraulic-pressure control valves in the control valve 50. An oil passage formed within the hydraulic circuit 51 is changed by selectively energizing or de-energizing these hydraulic-pressure control valves 52 (more specifically, electromagnetic solenoids of the hydraulic-pressure control valves 52). Thus, the engaged/disengaged state of the brakes B and clutches C is changed. As a result, the automatic transmission 12 is shifted to a desired gear. Note that, electromagnetic solenoid valves are used as the hydraulic-pressure control valves 52.

The hydraulic-pressure control valves 52 are formed integrally with respective electronic controllers 53. Each electronic controller 53 includes a CPU, a ROM, a memory, an input port, an output port, etc. The CPU performs various calculations. The ROM stores programs and data that are required for the calculations. The memory temporarily stores the results of calculations performed by the CPU. Signals are transmitted between the electronic controller 53 and external devices through the input port and the output port. In addition, the electronic controller 53 includes a nonvolatile memory 54 that stores data (more specifically, EEPROM), a drive circuit that supplies a drive current to the hydraulic-pressure control valve 52 (more specifically, the electromagnetic solenoid of the hydraulic-pressure control valve 52), etc.

A shift lever device 14 is provided near the driver's seat in the vehicle 10. The driver manually operates the shift lever device 14 to select a desired shift position from among multiple shift positions The shift positions that may be selected by the shift lever device 14 are Park (P), Reverse (R), Neutral (N), and Drive (D). P and N are the shift positions that are selected when the vehicle is stopped. R is the shift position that is selected when the vehicle is moved backward. D is the shift position that is selected when the vehicle is moved forward.

In the drive control over the vehicle 10, the operation state of the hydraulic-pressure control valves 52 is changed based on the shift position selected by the shift lever device 14, in other words, the engaged/disengaged state of the clutches C and the brakes B is changed based on the shift position selected by the shift lever device 14. As a result, the automatic transmission 12 is shifted to a desired gear.

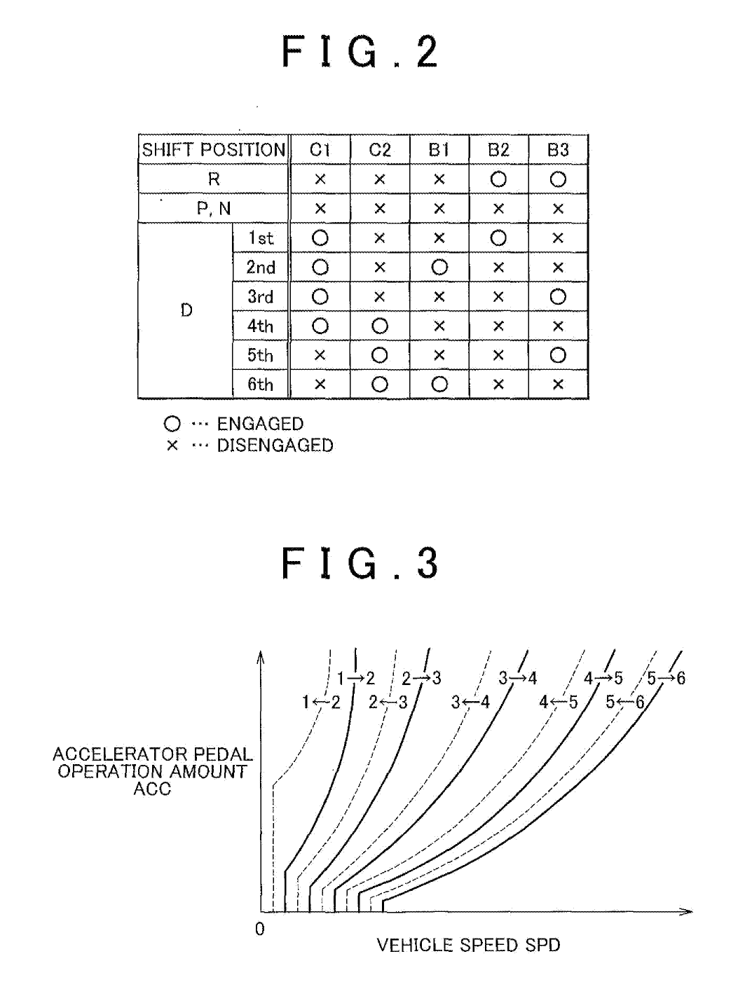

FIG. 2 shows the relationship between the engaged/disengaged state of the clutches C and brakes B of the automatic transmission 12 and the shift position selected by the shift lever device 14. In FIG. 2, a circle indicates that the clutch C or brake B is engaged, and a cross indicates that the clutch C or the brake B is disengaged.

As shown FIG. 2, when N or P is selected, the first clutch C1, the second clutch C2, the first brake B1, the second brake B2, and the third Brake B3 are all disengaged. At this time, the automatic transmission 12 is disconnected from the output shaft 13 of the internal combustion engine 11 so that the automatic transmission 12 does not transmit the drive power from the internal combustion engine 11 to the drive wheels.

When R is selected, the second brake B2 and the third brake B3 are engaged. At this time, the automatic transmission 12 is shifted to the reverse gear. When D is selected, the engaged/disengaged state of the clutches C and the brakes B is automatically changed to one of the six engaged/disengaged states that correspond to six forward gears. The six forward gears are first gear, second gear, third gear, fourth gear, fifth gear and sixth gear. As a result, the automatic transmission 12 is automatically shifted to one of the forward gears from first gear to sixth gear.

When the automatic transmission 12 is shifted to first gear, the first clutch C1 and the second brake B2 are engaged. When the automatic transmission 12 is shifted to second gear, the first clutch C1 and the first brake B1 are engaged. When the automatic transmission 12 is shifted to third gear, the first clutch C1 and the third brake B3 are engaged. When the automatic transmission 12 is shifted to fourth gear, the first clutch C1 and the second clutch C2 are engaged. When the automatic transmission 12 is shifted to fifth gear, the second clutch C2 and the third brake B3 are engaged. When the automatic transmission 12 is shifted to sixth gear, the second clutch C2 and the first B1 are engaged.

In the embodiment of the invention, when the automatic transmission 12 is shifted between forward gears, so-called clutch-to-clutch gear shift control is executed. In the clutch-to-clutch gear shift control, one element among the clutches C and brakes B, which has been engaged (disengagement-target change-over mechanism), is disengaged, and, simultaneously, another element among the clutches C or brakes B, which has been disengaged (engagement-target change-over mechanism), is engaged.

When the clutch-to-clutch gear shift control is executed, in order to shift the automatic transmission 12 to a desired gear quickly while suppressing occurrence of shift shock, the hydraulic pressure that is supplied to the disengagement-target change-over mechanism (hereinafter, referred to as “disengagement supply hydraulic pressure”) and the hydraulic pressure that is supplied to the engagement-target change-over mechanism (hereinafter, referred to as “engagement supply hydraulic pressure”) are controlled. The disengagement supply hydraulic pressure and the engagement supply hydraulic pressure are controlled by controlling the opening amount of the hydraulic-pressure control valve 52 that corresponds to the disengagement-target change-over mechanism and the opening amount of the hydraulic-pressure control valve 52 that corresponds to the engagement-target change-over mechanism, in addition to changing the energized/de-energized state of the hydraulic-pressure control valves 52.

The gear of the automatic transmission 12 is changed among first gear to sixth gear based on, for example, a shift map shown in FIG. 3. As shown FIG. 3, the shift map has shift lines (up-shift lines and down-shift lines) that are defined based on the relationship between a vehicle speed SPD of the vehicle 10 and an operation amount of an accelerator pedal 15 (hereinafter, referred to as “accelerator pedal operation amount ACC”). When the drive state of the vehicle 10 (the point indicating the relationship between the vehicle speed SPD and the accelerator pedal operation amount ACC) changes and crosses the shift line that is defined in the shift map, the gear of the automatic transmission 12 is shifted to a gear that corresponds to the target drive state. When the gear of the automatic transmission 12 is changed among the forward gears based on the shift map, the higher the vehicle speed SPD of the vehicle 10 is or the smaller the accelerator pedal operation amount ACC is, the higher gear that has the lower gear ratio is selected.

As shown FIG. 1, the vehicle 10 includes various sensors such as an accelerator pedal operation amount sensor 61 that detects the accelerator pedal operation amount ACC, and an output rotational speed sensor 62 that detects the rotational speed of the output gear 43 (output rotational speed NTo). In addition, the vehicle 10 includes a shift position sensor 63 that detects the shift position selected by the shift lever device 14, an input rotational speed sensor 64 that detects the rotational speed of the output shaft 21 of the torque converter 20 (input rotational speed NTi), etc. In the embodiment of the invention, the vehicle speed SPD of the vehicle 10 is detected based on the output rotational speed NTo.

The vehicle 10 is provided with an electronic control unit 60. The electronic control unit 60 includes a CPU, a ROM, a memory, an input port, an output port, etc. The CPU performs various calculations. The ROM stores programs and data that are required for the calculations. The memory temporarily stores the results of the calculations performed by the CPU. Signals are transmitted between the electronic controller 53 and external devices through the input port and the output port. The electronic control unit 60 receives detection signals from the various sensors. The electronic control unit 60 performs various calculations based on the detection signals from the various sensors, and executes power train control, for example, drive control over the internal combustion engine 11 and operation control over the automatic transmission 12.

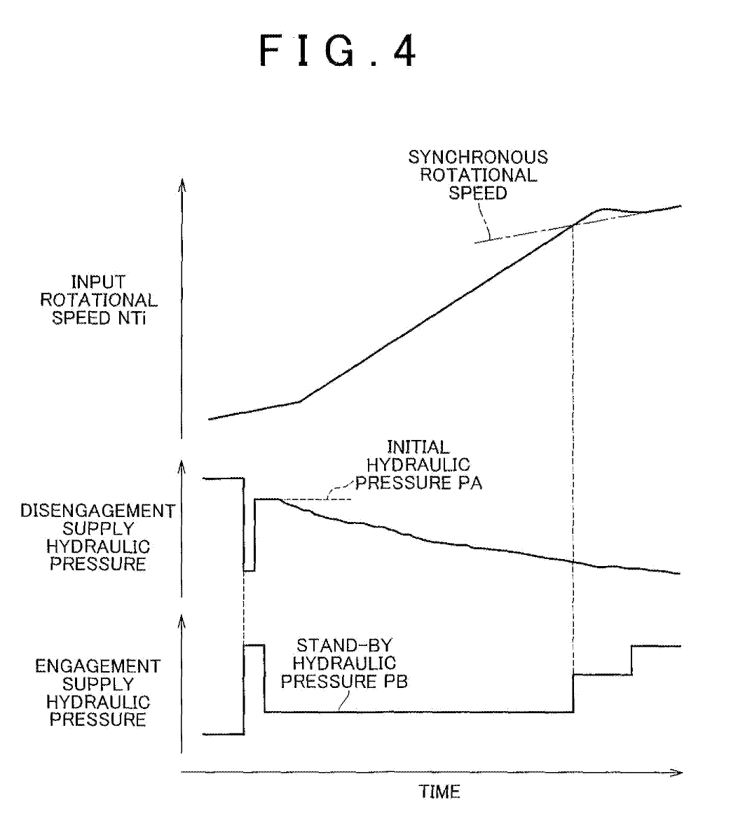

The electronic control unit 60 executes the above-described clutch-to-clutch gear shift control, as one of the operation controls over the automatic transmission 12. FIG. 4 shows an example of a manner in which the clutch-to-clutch gear shift control is executed.

In the clutch-to-clutch gear shift control shown in FIG. 4, first, the disengagement supply hydraulic pressure is regulated to an initial hydraulic pressure PA, and is then gradually decreased from the initial hydraulic pressure PA. Thus, the disengagement-target change-over mechanism, which has been engaged, is gradually disengaged. In accordance with this, the input rotational speed NTi is gradually increased. At this time, the engagement supply hydraulic pressure is maintained at a stand-by hydraulic pressure PB. Thus, the engagement-target change-over mechanism is kept disengaged.

A synchronous rotational speed is calculated by multiplying a gear ratio Rn, which is achieved as a result of shifting gears of the automatic transmission 12, by the output rotational speed NTo. When the synchronous rotational speed value is equal to the input rotational speed NTi (Rn×NTo=NTi), it is determined that the speed of rotation that is input in the engagement-target change-over mechanism matches the speed of rotation that is output from the engagement-target change-over mechanism, and the engagement supply hydraulic pressure is changed to a predetermined hydraulic pressure which is higher than the stand-by hydraulic pressure PB. Thus, the engagement-target change-over mechanism is engaged.

Immediately after being engaged, the engagement-target change-over mechanism is temporarily placed in the half-engaged state, and the input rotational speed NTi overshoots the value obtained by multiplying the output rotational speed NTo by the gear ratio Rn (Rn×NTo<NTi). Then, the engagement-target change-over mechanism is engaged, and the input rotational speed NTi matches the value obtained by multiplying the output rotational speed NTo by the gear ratio Rn (Rn×NTo=NTi).

As described above, in the clutch-to-clutch gear shift control, the engaged/disengaged state of the disengagement-target change-over mechanism and the engaged/disengaged state of the engagement-target change-over mechanism are changed in a predetermined pattern. Thus, it is possible to shift the automatic transmission 12 to a desired gear quickly while suppressing occurrence of shift shock.

The clutch-to-clutch gear shift control is executed when an execution condition is satisfied, for example, when the vehicle 10 is placed in a drive state in which the automatic transmission 12 should be shifted to a lower gear in response to depression of the accelerator pedal 15 while the vehicle 10 is running forward.

When the clutch-to-clutch gear shift control is executed, the initial hydraulic pressure PA and the stand-by hydraulic pressure PB are calculated according to the corresponding map based on the current vehicle speed SPD and the current gear shift mode. The gear mode means the combination of the originally-selected gear and the target gear, for example, sixth gear to fifth gear, fifth gear to fourth gear, third gear to second gear, second gear to first gear.

The relationship between the vehicle drive state that is defined based on the vehicle speed SPD of the vehicle 10 and the shift mode, and a value corresponding to the disengagement supply hydraulic pressure at which the clutch-to-clutch gear shift control is executed appropriately when the actual operation characteristics of each hydraulic-pressure control valves 52 match the reference characteristics (standard operation characteristics) is obtained in advance, and set in the map used to calculate the initial hydraulic pressure PA. In addition, the relationship between the vehicle drive state that is defined based on the vehicle speed SPD of the vehicle 10 and the shift mode, and a value corresponding to the engagement supply hydraulic pressure at which the clutch-to-clutch gear shift control is executed appropriately when the actual operation characteristics of the hydraulic-pressure control valves 52 match the reference characteristics is obtained in advance, and set in the map used to calculate the stand-by hydraulic pressure PB.

If the clutch-to-clutch gear shift control is executed based on the initial hydraulic pressure PA and the stand-by hydraulic pressure PB that are calculated in the above-described manner, it is possible to execute the clutch-to-clutch gear shift control appropriately to some extent. However, because there is an individual difference among the hydraulic-pressure control valves 52, even if the same magnitude of drive current is supplied to each of the hydraulic-pressure control valves 52, the hydraulic-pressure control valves 52 are not always in the same operation condition. Therefore, even if the drive currents, which are commensurate with the initial hydraulic pressure PA and the stand-by hydraulic pressure PB that are calculated in the above-described manner, are supplied to the hydraulic-pressure control valves 52, some errors may be caused in the disengagement supply hydraulic pressure and the engagement supply hydraulic pressure that are supplied to the hydraulic-pressure control valves 52.

In the embodiment of the invention, values that are used to compensate for the errors caused due to the individual difference are obtained in advance and stored in the electronic controllers 53, more specifically, in the nonvolatile memories 54 of the electronic controllers 53. The relationship between the electric current supplied to each hydraulic-pressure control valve 52 (supply current) and the disengagement supply hydraulic pressure (or engagement supply hydraulic pressure) is measured at multiple measurement points. This measurement is executed on each of all the hydraulic-pressure control valves 52. The obtained relationship is stored in the nonvolatile memory 54 of the corresponding electronic controller 53.

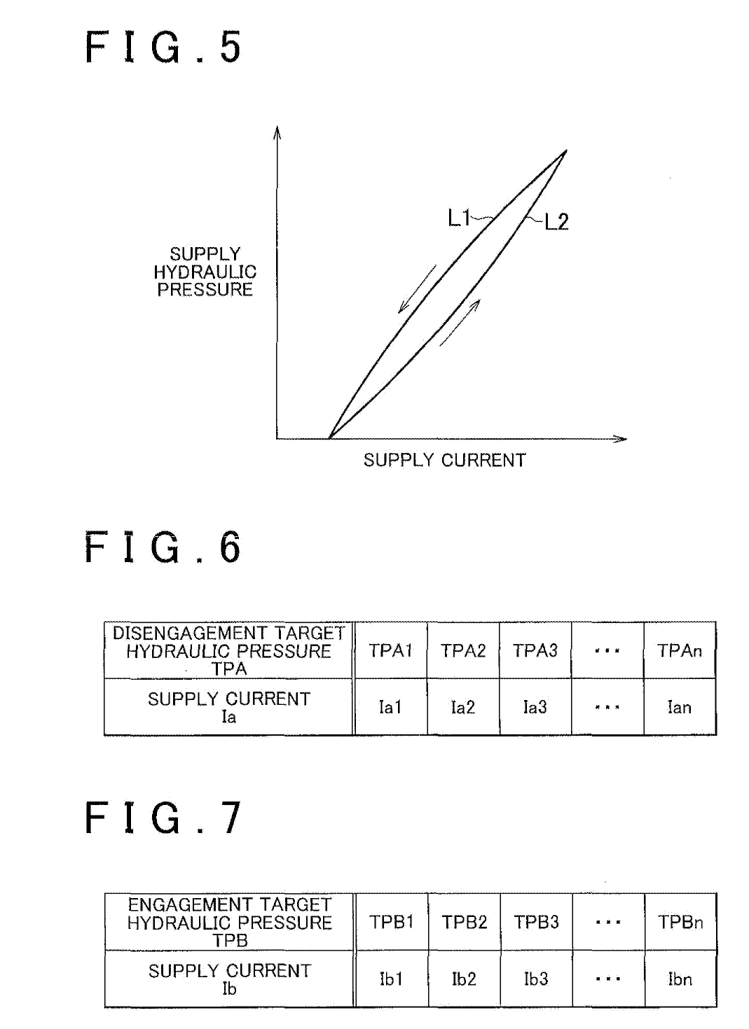

A hydraulic-pressure control valve of which the operation condition is changed by a change in an electric current that is supplied to an electromagnetic solenoid thereof is used as the hydraulic-pressure control valve 52. Therefore, as shown FIG. 5, the relationship between the electric current that is supplied to the hydraulic-pressure control valve 52 and the hydraulic pressure that is supplied to the change-over mechanism is different between when the electric current that is supplied to the hydraulic-pressure control valve 52 is decreased to decrease the disengagement supply hydraulic pressure (indicated by a line L1) and when the electric current that is supplied to the hydraulic-pressure control valve 52 is increased to increase the engagement supply hydraulic pressure (indicated by a line L2).

Taking the fact into account, in the embodiment of the invention, the above-described relationship when the electric current that is supplied to the hydraulic-pressure control valve 52 is decreased in a predetermined manner, and the above-described relationship when the electric current that is supplied to the hydraulic-pressure control valve 52 is increased in a predetermined manner are measured separately. The relationship which is achieved when the supply current is decreased is stored as the relationship shown in the map in FIG. 6, that is, the relationship between a control target value (disengagement target hydraulic pressure TPA) of the disengagement supply hydraulic pressure and a supply current Ia. In addition, the relationship which is achieved when the supply current is increased is stored as the relationship shown in the map in FIG. 7, that is, the relationship between the control target value (engagement target hydraulic pressure TPB) of the engagement supply hydraulic pressure and a supply current Ib.

In the control system according to the embodiment of the invention, the clutch-to-clutch gear shift control is executed based on the above-described relationships which are stored in the electronic controller 53. The electronic control unit 60 calculates the initial hydraulic pressure PA, and calculates the disengagement target hydraulic pressure TPA based on the initial hydraulic pressure PA. A signal indicating the disengagement target hydraulic pressure TPA is output from the electronic control unit 60 and input in the electronic controller 53 that is formed integrally with the hydraulic-pressure control valve 52 that corresponds to the disengagement-target change-over mechanisms. Hereinafter, the hydraulic-pressure control valve 52 that corresponds to the disengagement-target change-over mechanism will be referred to as “hydraulic-pressure control valve 52A”, and the electronic controller 53 that is formed integrally with the hydraulic-pressure control valve 52A will be referred to as “electronic controller 53A”. After that, the electronic controller 53A controls the drive circuit so that the electric current Ia, at which the actual disengagement supply hydraulic pressure matches the disengagement target hydraulic pressure TPA, is output to the hydraulic-pressure control valve 52A based on the relationship stored in the nonvolatile memory 54 (see FIG. 6) and the disengagement target hydraulic pressure TPA. As a result, the disengagement supply hydraulic pressure is accurately controlled in a desired manner independently of the individual difference among the hydraulic-pressure control valves 52.

In addition, the electronic control unit 60 calculates the stand-by hydraulic pressure PB, and calculates the engagement target hydraulic pressure TPB based on the stand-by hydraulic pressure PB. A signal indicating the engagement target hydraulic pressure TPB is output from the electronic control unit 60 and input in the electronic controller 53 that is formed integrally with the hydraulic-pressure control valve 52 that corresponds to the engagement-target change-over mechanism. Hereinafter, the hydraulic-pressure control valve 52 that corresponds to the engagement-target change-over mechanism will be referred to as “hydraulic-pressure control valve 52B”, and the electronic controller 53 that is formed integrally with the hydraulic-pressure control valve 52B will be referred to as “electronic controller 53B”. After that, the electronic controller 53B controls the drive circuit so that the electric current Ib, at which the actual engagement supply hydraulic pressure matches the engagement target hydraulic pressure TPB, is output to the hydraulic-pressure control valve 52B based on the relationship stored in the nonvolatile memory 54 (see FIG. 7) and the engagement target hydraulic pressure TPB. As a result, the engagement supply hydraulic pressure is accurately controlled in a desired manner independently of the individual difference among the hydraulic-pressure control valves 52.

In the control system according to the embodiment of the invention, even if the hydraulic-pressure control valve 52 or the electronic control unit 60 is replaced, the operation control over each hydraulic-pressure control valve 52 is executed in accordance with the actual operation characteristics, based on the relationship (see FIG. 6 and FIG. 7) that is stored in the electronic controller 53 which is formed integrally with each hydraulic-pressure control valve 52.

In a conventional control system in which the information regarding the operation characteristics (characteristic information) of a hydraulic-pressure control valve is stored in an electronic control unit that is provided separately from the hydraulic-pressure control valve, when the hydraulic-pressure control valve or the electronic control unit is replaced, it is necessary to do the following work in addition to the work for the replacement in order to control the operation of the hydraulic-pressure control valve in accordance with the actual operation characteristics.

When the hydraulic-pressure control valve is replaced, the characteristic information of the newly-fitted hydraulic-pressure control valve is stored in the electronic control unit. When the electronic control unit is replaced, the characteristic information of the hydraulic-pressure control valve is stored in the newly-fitted electronic control unit.

In contrast, in the control system according to the embodiment of the invention, even if the hydraulic-pressure control valve 52 or the electronic control unit 60 is replaced, it is not necessary to execute an extra work to store the characteristic information in the electronic control unit 60. Accordingly, in the control system according to the embodiment of the invention, a work that is required to replace the hydraulic-pressure control valve 52 or the electronic control unit 60 is simpler than that in the conventional control system in which the work for storing the characteristic information in the electronic control unit is required.

The electronic controller 53 is formed integrally with the hydraulic-pressure control valve 52. Each of the electronic controller 53 stores the relationship (see FIGS. 6 and 7) concerning the hydraulic-pressure control valve 52 that is formed integrally with this electronic controller 53. Therefore, it is possible to replace the hydraulic-pressure control valve 52 through a simple work.

In addition, the same effect is obtained not only when the control valve 52 or the electronic control unit 60 is replaced but also when the vehicle to is assembled. In other words, when the vehicle 10 is assembled, it is not necessary to do an extra work to store the characteristic information in the electronic control unit 60. Accordingly, a work that is required to assemble the vehicle 10 is simpler than a work that is required to assemble a vehicle in which the extra work for storing the characteristic information in an electronic control unit is required.

To improve the efficiency of the work for assembling the vehicle, preferably, the characteristic information is stored in the electronic control unit in advances. To realize this configuration in the conventional control system in which the characteristic information is stored in the electronic control unit that is formed separately from the hydraulic-pressure control valve, the following complicated work may be required if the manufacturer of the hydraulic-pressure control valve is different from the manufacturer of the electronic control unit.

In this case, the manufacturer of the hydraulic-pressure control valve obtains the characteristic information regarding each hydraulic-pressure control valve and informs the manufacturer of the electronic unit of the characteristic information. The manufacturer of the electronic control unit stores the characteristic information of each hydraulic-pressure control valve in the corresponding electronic control unit.

To clarify the correspondence relationship between the hydraulic-pressure control valves and the electronic control units, identification tags for identifying the hydraulic-pressure control valves are attached to the hydraulic-pressure control valves at the manufacturer of the hydraulic-pressure control valves, and identification tags for identifying the electronic control units are attached to the electronic control units at the manufacturer of the electronic control units. When the vehicle 10 is assembled, the identification tags are checked to match the hydraulic-pressure control valves and the electronic control units with each other appropriately.

In contrast, employment of the hydraulic-pressure control valves 52 according to the embodiment of the invention makes it possible for the manufacturer of the hydraulic-pressure control valves 52 to do both a work for obtaining the characteristic information (more specifically, the relationships shown in FIGS. 6 and 7) concerning the hydraulic-pressure control valves 52 and a work for storing the characteristic information in the electronic controllers 53.

If the embodiment of the invention is employed, it is possible to save the inconvenience of doing various cumbersome works, for example, the work for exchanging the characteristic information between the manufacturer of the hydraulic-pressure control valves and the manufacturer of the electronic control units, the work for attaching the identification tags to the hydraulic-pressure control valves and the electronic control units, and the work for checking the identification tags when the vehicle is assembled. As a result, it is possible to enhance the efficiency of production and assembly of the control system and, eventually, the efficiency of production and assembly of the vehicle 10.

As described above, the embodiment of the invention produces the following effects. 1) The characteristic information of the hydraulic-pressure control valve 52 is stored in the electronic controller 53 that is formed integrally with this hydraulic-pressure control valve 52. Therefore, even if the hydraulic-pressure control valve 52 or the electronic control unit 60 is replaced, the operation of the hydraulic-pressure control valve 52 is controlled in accordance with the actual operation characteristics, based on the characteristic information stored in the electronic controller 53. Accordingly when the hydraulic-pressure control valve 52 or the electronic control unit 60 is replaced, it is not necessary to do an extra work to store the characteristic information in the electronic control unit 60. As a result, the work for replacing the hydraulic-pressure control valve 52 or the electronic control unit 60 in the control system according to the invention is simpler than that in the conventional control system in which the work for storing the characteristic information in the electronic control unit is required.

2) The multiple hydraulic pressure control valves 53 with the integrally-formed electronic controllers 53 are provided. Each electronic controller 53 stores the characteristic information regarding the integrally-formed hydraulic-pressure control valve 52. Therefore, it is possible to replace the hydraulic-pressure control valve through a simple work.

The embodiment of the invention may be modified as follows. The characteristic information that is stored in the electronic controller 53 in advance is not limited to the relationship between the electric current that is supplied to the hydraulic-pressure control valve 52 and the hydraulic pressure that is supplied to the change-over mechanism. For example, a correction value which is used to correct, for example, the disengagement target hydraulic pressure TPA or the engagement target hydraulic pressure TPB may be used as the characteristic information. In other words, any type of value may be stored in the electronic controller 53 in advance as long as the value makes it possible to compensate for the deviation of the actual value of the hydraulic pressure that is supplied to the change-over mechanism (disengagement supply hydraulic pressure or engagement supply hydraulic pressure) from the target value (disengagement target hydraulic pressure TPA or engagement target hydraulic pressure TPB). Such deviation is caused by the deviation of the actual operation characteristics of the hydraulic-pressure control valve 52, which are achieved immediately after the hydraulic-pressure control valve 52 is fitted to the vehicle 10, from the reference characteristics.

When a learning control is executed to compensate for an error in the control parameter used in the clutch-to-clutch gear shift control, which is caused due to a change in characteristics of the hydraulic-pressure control valve 52 with time, a learned value that is calculated in the learning control may be stored in the electronic controller 53. According to this modified embodiment, when the hydraulic-pressure control valve 52 is replaced, the hydraulic-pressure control valve 52 provided with the electronic controller 53 in which the learned value is stored in advance as the initial value is newly fitted. Accordingly, the work for replacing the hydraulic pressure valve 52 according to the modified embodiment is simpler than that in the control system in which the learned value is stored in the electronic control unit 60, because a work for resetting the learned value to the initial value is omitted. When the electronic control unit 60 is replaced, it is not necessary to do a work for moving the leaned value concerning each hydraulic-pressure control valve 52 from the electronic control unit 60 that is removed to the electronic control unit 60 that is newly fitted. Therefore, the work for replacement is simpler than that in the control system in which the learned value is stored in the electronic control unit 60.

The process for executing the clutch-to-clutch gear shift control may be modified as follows. First, immediately after the hydraulic-pressure control valve 52 or the electronic control unit 60 is replaced, the process for storing the characteristic information, which is stored in the electronic controller 53 of each hydraulic-pressure control valve 52 in advance, in the electronic control unit 60 is executed. Then, all the calculations for executing the clutch-to-clutch gear shift control are performed by the electronic control unit 60 based on the characteristic information that is stored in the electronic control unit 60, and the operation of the hydraulic control valve 52 is controlled based on the results of the calculations.

In the control system that executes the clutch-to-clutch gear shift control, the electronic controller that is formed integrally with the hydraulic-pressure control valve 52 is not limited to the electronic controller 53 described above. As the electronic controller 53, any type of electronic controller may be employed as long as the electronic controller includes a storage unit that stores the characteristic information regarding the hydraulic-pressure control valve 52 and a communication unit that is used to perform data communication between the storage unit and the electronic control unit 60.

The electronic controller 53 may execute part of the process for executing the clutch-to-clutch gear shift control. For example, the electronic controller 53 that corresponds to the disengagement-target change-over mechanism may execute the process for calculating the disengagement target hydraulic pressure TPA, or the electronic controller 53 that corresponds to the engagement-target change-over mechanism may execute the process for calculating the engagement target hydraulic pressure TPB.

When the hydraulic-pressure control valves 52 are applied to multiple types of control valves, correction values that are commensurate with the respective types of control valves may be obtained in advance, the correction values for the control valves, to which the hydraulic-pressure control valves 52 are applied, may be reflected on the results of the measurements of the characteristic information regarding the respective hydraulic-pressure control valves 52, and then the characteristic information may be stored in the electronic controllers 53.

The invention may be applied not only to the control system that includes multiple hydraulic-pressure control valves but also to a control system that includes only one hydraulic-pressure control valve and the hydraulic-pressure control valve included in the control system.

The invention may be applied to, for example, a control system that controls the operation of an actuator other than a hydraulic-pressure control valve, such as a throttle valve that adjusts the flow passage area of the passage of an intake air passage of an engine, or a fuel injection valve that supplies the fuel into a combustion chamber of an engine. Also, the invention may be applied to the actuator that is included in the control system described above. In other words, the invention may be applied to a system which includes a storage unit that stores the information regarding the operation characteristics of an actuator in advance and a control unit that controls the operation of the actuator based on the characteristic information, and in which the control unit is formed separately from the actuator, and the actuator included in the control system.

While the invention has been described with reference to an example embodiment thereof, it is to be understood that the invention is not limited to the example embodiment or constructions. To the contrary, the invention is intended to cover various modifications and equivalent arrangements. In addition, while the various elements of the exemplary embodiments are shown in various combinations and configurations, which are exemplary, other combinations and configurations, including more, less or only a single element, are also within the scope of the invention.

What is claimed is:

1. A control system for an actuator, comprising:
a storage unit that stores information regarding operation characteristics of the actuator in advance; and
a control unit that controls an operation of the actuator based on the information, and that is formed separately from the actuator,
wherein the actuator and the storage unit are formed integrally with each other.

2. The control system according to claim 1, wherein:
the control system includes a plurality of the actuators which are formed integrally with the respective storage units; and
each storage unit stores tile information regarding the actuator that is formed integrally with the storage unit.

3. The control system according to claim 1, wherein:
the control system is applied to an automatic transmission that has a plurality of gears;
the automatic transmission includes a hydraulically-actuated change-over mechanism that selectively connects two components with each other or disconnects the two components from each other to change the gears; and
the actuator is a hydraulic-pressure control valve that adjusts a supply hydraulic pressure which is supplied to the change-over mechanism.

4. The control system according to claim 3, wherein the information is a value that is used to compensate for deviation of an actual value of the supply hydraulic pressure from a target value, which is caused due to deviation of actual operation characteristics of the actuator immediately after fitting of the control system is completed from reference characteristics.

5. The control system according to claim 1, wherein:
the control system is applied to a throttle valve that adjusts a flow passage area of an intake passage of an internal combustion engine; and
the actuator is the throttle valve.

6. The control system according to claim 1, wherein:
the control system is applied to a fuel injection valve that supplies fuel into a combustion chamber of an internal combustion engine; and
the actuator is the fuel injection valve.

7. An actuator, comprising;
a storage unit that stores information regarding operation characteristics of the actuator in advance; and
a control unit that controls an operation of the actuator based on the information,
wherein the actuator is applied to a control system in which the control unit is formed separately from the actuator, and
wherein the actuator is formed integrally with the storage unit.

8. The actuator according to claim 7, wherein the actuator is a hydraulic-pressure control valve that is provided in an automatic transmission which includes a hydraulically-actuated change-over mechanism that selectively connects two components with each other or disconnects the two components from each other to change gears, and that adjusts a supply hydraulic pressure which is supplied to the change-over mechanism.

9. The actuator according to claim 8, wherein the information is a value that is used to compensate for deviation of an actual value of the supply hydraulic pressure from a target value, which is caused due to deviation of actual operation characteristics of the actuator immediately after fitting of the control system is completed from reference characteristics.

10. The actuator according to claim 7, wherein the actuator is a throttle valve that adjusts a flow passage area of an intake passage of an internal combustion engine.

11. The actuator according to claim 7, wherein the actuator is a fuel injection valve that supplies fuel into a combustion chamber of an internal combustion engine.
